(19) United States
(12) Patent Application Publication
(10) Pub. No.: US 2008/0235726 A1
(43) Pub. Date: Sep. 25, 2008

(54) Television broadcast receiver

(75) Inventors: Hideki Sakao, Sagamihara (JP); Koichi Terada, Kamakura (JP); Norikazu Sasaki, Ebina (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 12/077,409

(22) Filed: Mar. 17, 2008

(30) Foreign Application Priority Data
Mar. 23, 2007 (JP) 2007-077369

(51) Int. Cl. H04N 5/445; H04N 7/16

(52) U.S. Cl. 725/38; 725/139

(57) ABSTRACT

An object of the present invention is to provide a function to make a reservation for recording or watching with a simple operation during watching a program promotion, by adding a function to acquire the information required to make a reservation from the program promotion being watched. For the achievement of the object, a character recognition processing unit and an audio recognition processing unit extract keywords from video information and audio information contained in video information. Then, after the keywords are transferred to a keyword managing unit, a program information processing unit appropriately shows the program information to an operator. The operator can make the reservation simply by selecting the presented program information.

### CROSS-REFERENCE TO RELATED APPLICATION

This application claims priority from Japanese Patent Application JP 2007-077369 filed on Mar. 23, 2007, the content of which is hereby incorporated by reference into this application.

### TECHNICAL FIELD OF THE INVENTION

The present invention relates to an apparatus that receives television broadcasts to record or reproduce the same. More particularly, it relates to an apparatus having a reservation function for television broadcasts.

### BACKGROUND OF THE INVENTION

Some television broadcast receivers such as television sets and video recorders have a reservation function that ensures a viewer to watch and/or record a certain television program. The reservation of a program desired to be watched or recorded is performed by operator's instructions including several pieces of information such as a selected channel and start and finish times of the watching or the recording for a television broadcast receiver.

Several methods have been provided as means for instructing the information required for the reservation.

For example, in Japanese Patent Application Laid-Open Publication No. 2006-253895, a program reservation information acquiring ID is delivered to a mobile terminal along with a broadcasting of a program from a base station. When a user intends to record the program corresponding to the program reservation information acquiring ID, the user sends the program reservation information acquiring ID to a reservation information delivery server from the mobile terminal and acquires reservation information. Then, by transmitting the reservation information to a recorder, a recording reservation is made on the recorder.

### SUMMARY OF THE INVENTION

However, the invention disclosed in Japanese Patent Application Laid-Open Publication No. 2006-253895 has the following problems.

That is, the consideration for the case where the program information is provided only for a short time period, for example, during a program promotion is insufficient, and a viewer sometimes fails to acquire full information for the program which the viewer desires to reserve. Also, in the case where the information is acquired from a program promotion delivered when the viewer is watching another program, the currently watched program begins and the watching of the program is interrupted by the acquisition of the information in some cases.

An object of the present invention is to provide a function to make a reservation for recording or watching with a simple operation during watching a program promotion, by adding a function to acquire the information required to make a reservation from the program promotion being watched.

The above and other objects and novel characteristics of the present invention will be apparent from the description of this specification and the accompanying drawings.

The typical ones of the inventions disclosed in this application will be briefly described as follows.

A television broadcast receiver according to the present invention comprises: a decoding processing unit which decodes receiving wave to extract video data; and a video processing unit which processes the video data into imaging data, wherein the television broadcast receiver further comprises a character recognition processing unit which extracts a character string from the imaging data.

The character recognition processing unit of the television broadcast receiver extracts one or more keywords from the character string.

A television broadcast receiver according to the present invention comprises: a decoding processing unit which decodes receiving wave to extract audio data; and an audio processing unit which converts the audio data into audio output data, wherein the television broadcast receiver further comprises an audio recognition processing unit which extracts a character string from the audio output data.

The audio recognition processing unit of the television broadcast receiver extracts one or more keywords from the character string.

These television broadcast receivers further comprises: a program information processing unit; and a keyword managing unit, wherein the character recognition processing unit transmits one or more of the extracted keywords to the keyword managing unit, the keyword managing unit holds the keywords to be operable by the program information processing unit, and the program information processing unit determines priority of the keywords held by the keyword managing unit.

The program information processing unit of the television broadcast receiver acquires a program table via a network to determine the priority of the keywords by referring to the program table. Further, the program information processing unit generates selection screen data for program reservation by referring to the priority of the keywords. This television broadcast receiver further comprises a GUI controlling unit, wherein the program information processing unit transmits the selection screen data to the GUI controlling unit, and the GUI controlling unit displays reservation candidates in a selectable manner by referring to the selection screen data.

The television broadcast receiver according to the present invention further comprises a memory buffer, wherein the memory buffer provides a predetermined delay time before the decoding by the decoding processing unit.

The effects obtained by typical aspects of the present invention will be briefly described below.

An operator of the television broadcast receiver can make a reservation by performing only two steps of starting the acquisition of the reservation information and checking the reservation, and the acquisition of the information required for the reservation can be automatically performed from the program promotion. Therefore, it is possible to reduce an operation load of the viewer such as memorizing a broadcasting time. Further, it is possible to obtain an effect that currently watching program is prevented from being interrupted.

### BRIEF DESCRIPTIONS OF THE DRAWINGS

FIG. 1 is an entire configuration diagram of hardware and software of a television broadcast receiver according to a first embodiment of the present invention;

FIG. 2 is a flow chart showing a reservation processing in an input information processing unit of the television broadcast receiver according to the first embodiment of the present invention;

FIG. 3 is a flow chart showing a processing in a character recognition processing unit of the television broadcast receiver according to the first embodiment of the present invention;

FIG. 4 is a flow chart showing a processing in an audio recognition processing unit of the television broadcast receiver according to the first embodiment of the present invention;

FIG. 5 is a flow chart showing a processing in a program information processing unit and a keyword managing unit of the television broadcast receiver according to the first embodiment of the present invention;

FIG. 6 is an entire configuration diagram of hardware and software of a television broadcast receiver according to a second embodiment of the present invention; and

FIG. 7 is a flow chart showing a processing of operation from an operator's understanding of a program outline to watching of a program.

### DESCRIPTIONS OF THE PREFERRED EMBODIMENTS

The recording action of a viewer will first be analyzed.

### (Recording Action of Viewer)

When a viewer of a television program tries to watch or record a certain program, as a trigger thereof, it is necessary for the viewer to know an outline of the program to be broadcasted. A program promotion broadcasted from respective broadcasting stations can be taken as one of the means to know an outline of the program. The program promotion includes a digest of the program to be broadcasted, a program title and a broadcasting time of the program. The viewer understands the outline of the program through the program promotion and determines to watch or record the program that the viewer is interested in.

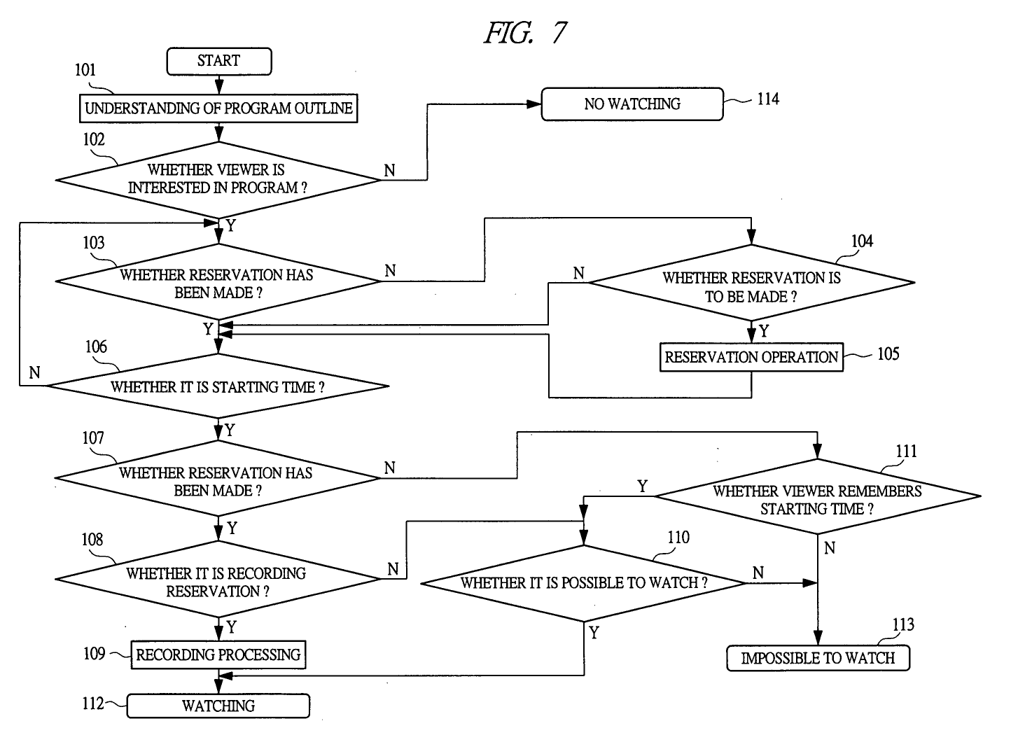

FIG. 7 is a flow chart showing the processing from understanding the outline of the program to watching the program. First, a viewer understands the outline of the program from the information of the program promotion (step S101), and determines whether or not the viewer is interested in the program (step S102). If not interested in the program (step S102: No), the viewer does not watch the program (step S114). If interested in the program (step S102: Yes), the viewer checks whether or not the program has been reserved (step S103), and if not reserved yet (step S103: No), the viewer determines whether to reserve the program or not (step S104). When the program is to be reserved, the viewer performs a reservation operation (step S105). The reservation operation is available up to a time when the program starts.

At a time of starting the broadcast (step S106: Yes), the following processing differs depending on whether or not the program has been reserved (step S107). Further, when the program has been reserved (step S107: Yes), the following processing differs depending on whether the reservation is the recording reservation or the watching reservation (step S108).

When the reservation for recording the program has been made (step S108: Yes), the television broadcast receiver records the program (step S109). Therefore, the viewer can watch the program at any time (step S112).

When the reservation for recording the program is not made (step S108: No) and only the reservation for watching the program (step S110: Yes) has been made, the television broadcast receiver starts to receive the program and displays the program. When the viewer is near the television broadcast receiver while the program is being displayed and can watch the television (step S110: Yes), the viewer can watch the program (step S112). When the viewer is not near the television broadcast receiver (step S110: No) or the viewer cannot watch the television, the viewer cannot watch the program (step S113).

On the other hand, when the reservation is not made (step S107: No), the result differs depending on whether or not the viewer remembers the broadcast starting time of the program (step S111). When the viewer remembers the broadcast starting time, similar to the case where the reservation for watching the program has been made, if the viewer is near the television broadcast receiver while the program is being displayed (step S110: Yes), the viewer can watch the program (step S112). However, when the viewer is not near the television broadcast receiver and cannot watch the TV (step S110: No), the viewer cannot watch the program (step S113). When the viewer does not remember the broadcast starting time, the viewer cannot watch the program (step S113).

### First Embodiment

The above-described recording action of a viewer is reflected in a first embodiment of the present invention. The first embodiment will be described below with reference to the drawings.

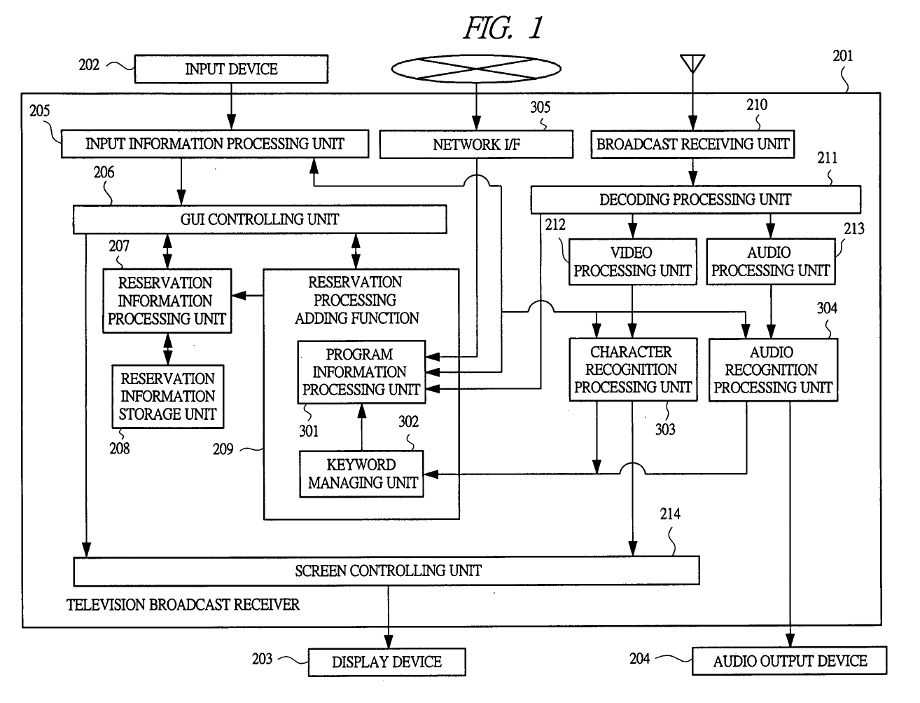

FIG. 1 is an entire configuration diagram of hardware/software of a television broadcast receiver 201 according to the first embodiment of the present invention.

The television broadcast receiver 201 includes an input information processing unit 205, a GUI controlling unit 206, a reservation information processing unit 207, a reservation information storage unit 208, a reservation processing adding function 209, a broadcast receiving unit 210, a decoding processing unit 211, a video processing unit 212, an audio processing unit 213, a screen controlling unit 214, a character recognition processing unit 303, and an audio recognition processing unit 304.

Also, an input device 202, a display device 203 and an audio output device 204 are provided as external peripherals.

The input information processing unit 205 processes a piece of information input by the operation of a viewer with the input device 202, for example, a remote controller, a bar code reader, a mouse and a keyboard.

The GUI controlling unit 206 receives the input information processed by the input information processing unit 205, creates information to be displayed on a screen in accordance with the input information and displays the information on the display device 203 via the screen controlling unit 214. Also, when the input information contains reservation information, the GUI controlling unit 206 transmits the reservation information to the reservation information processing unit 207.

The reservation information processing unit 207 processes the reservation information input from the GUI controlling unit 206 into an appropriate data format and stores the information in the reservation information storage unit 208.

The reservation processing adding function 209 is a collective unit of modules for realizing additional reservation functions. For example, the modules incorporated in the reservation processing adding function 209 process the inputs of G-code, bar code, EPG and the like.

As the modules for the reservation processing adding function 209, a program information processing unit 301 and a keyword managing unit 302 are included in the present invention.

The broadcast receiving unit 210 corresponds to a circuit that receives radio waves received via an antenna (receiving wave) or a device including the same. When the program to be watched is received via cable television system or satellite broadcasting, the broadcast receiving unit 210 which conforms to the relevant system is used. The broadcast receiving unit 210 performs analog/digital conversion of the receiving wave into TS (Transport Stream) that is digital data and then transmits the data to the decoding processing unit 211.

The decoding processing unit 211 decodes the received digital data to obtain meaningful video data, audio data or caption data. Specifically, a function to sort the received TS (Transport Stream) into video data, audio data or caption data is assumed. After being sorted, the video data is transmitted to the video processing unit 212 and the audio data is transmitted to the audio processing unit 213.

The video processing unit 212 converts the video data into actual display format (imaging data) so as to output the data on the display device 203. Also, the audio processing unit 213 converts the audio data into actual audio format (audio output data) so as to output the data through the audio output device 204.

In an ordinary television broadcast receiver, the imaging data processed by the video processing unit 212 is output to the display device 203 via the screen controlling unit 214. Also, audio output data is directly output through the audio output device 204. On the other hand, in the television broadcast receiver 201 according to the present invention, the imaging data processed by the video processing unit 212 is transmitted to the screen controlling unit 214 via the character recognition processing unit 303, while the audio output data processed by the audio processing unit 213 is transmitted to the audio output device 204 via the audio recognition processing unit 304.

The screen controlling unit 214 combines the imaging data from the GUI controlling unit 206 and the character recognition processing unit 303 to output the data from the display device.

The program information processing unit 301 acquires a program table of a currently receiving channel.

The keyword managing unit 302 is a module that extracts and manages characters to be keywords from character strings transmitted from the character recognition processing unit 303 or the audio recognition processing unit 304.

The character recognition processing unit 303 is a module that recognizes the character strings included in an image of the imaging data from the video processing unit 212.

The audio recognition processing unit 304 is a module that performs an audio recognition of character strings read out from the audio output data processed by the audio processing unit 213.

A network I/F 305 is an interface for connecting to a network to acquire information of a Web page of a currently receiving broadcasting station.

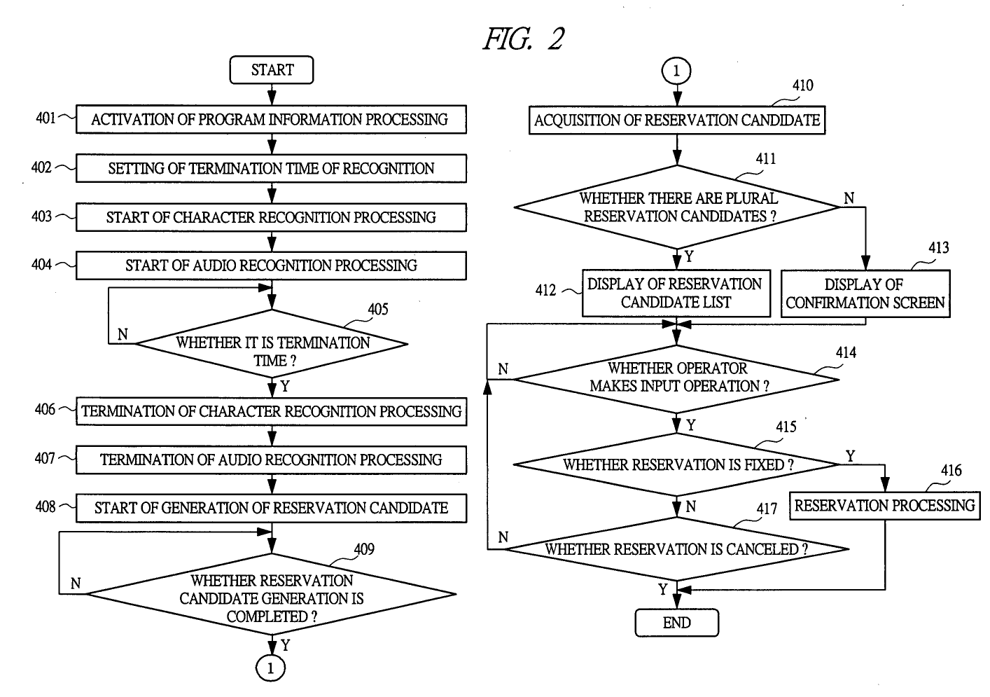

Next, the processing in the television broadcast receiver 201 will be described with reference to FIG. 2 to FIG. 5.

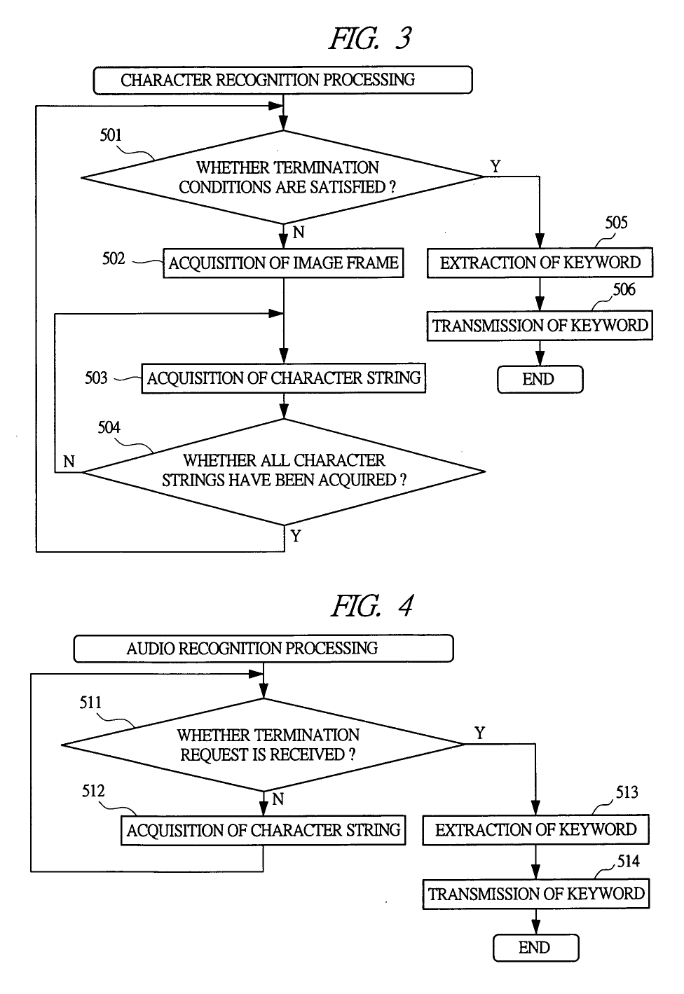

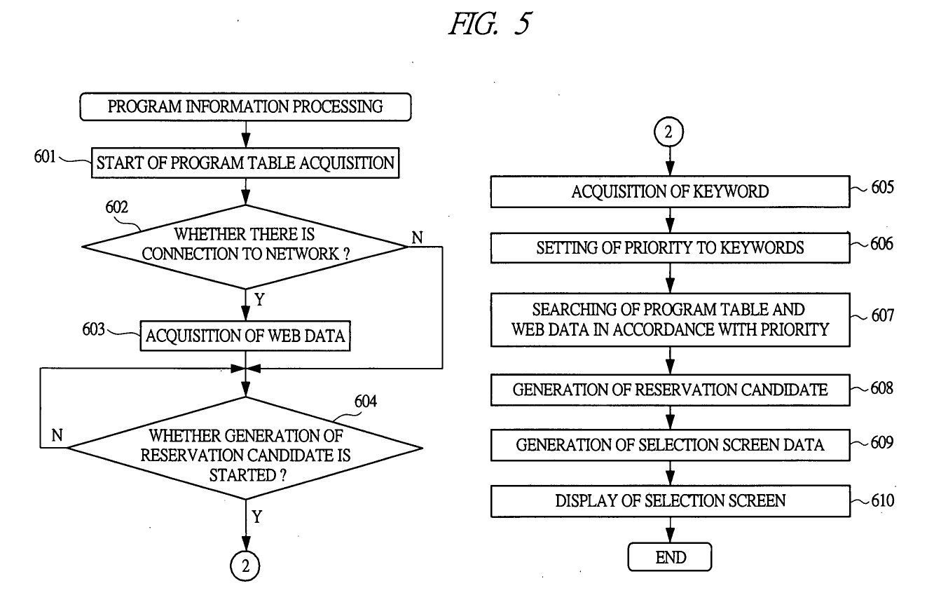

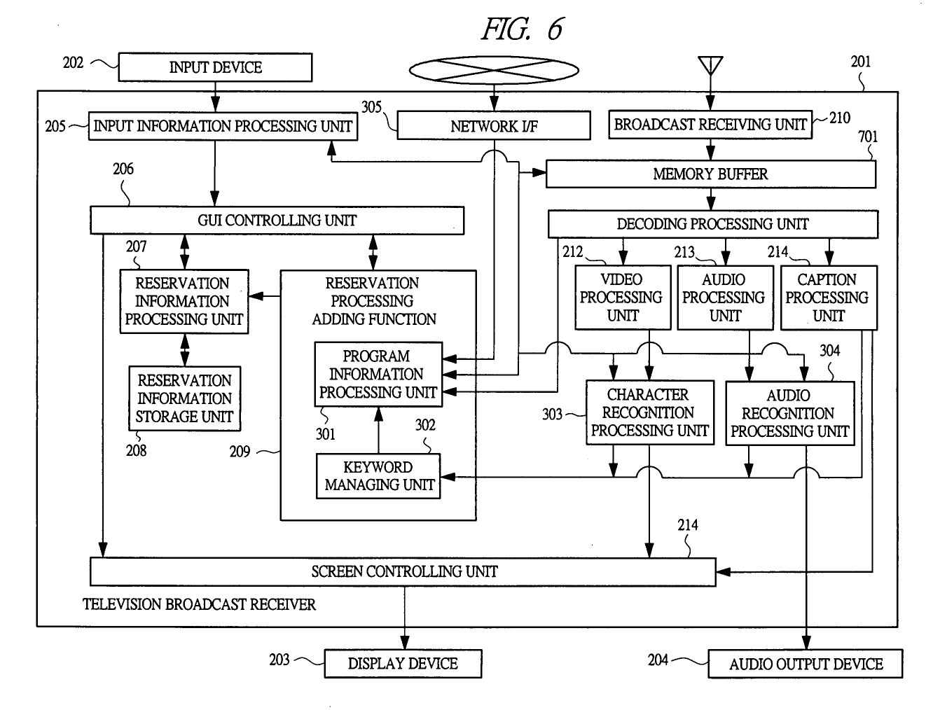

FIG. 2 is a flow chart showing a flow of a reservation processing from a program promotion performed in the input information processing unit 205. FIG. 3 is a flow chart showing a flow of a processing performed in the character recognition processing unit 303 and the audio recognition processing unit 304. FIG. 4 is a flow chart showing a flow of a processing performed in the audio recognition processing unit. Also, FIG. 5 is a flow chart showing a processing in the program information processing unit 301 and the keyword managing unit 302.

The reservation processing procedure from a program promotion will be described below with reference to FIG. 2 to FIG. 5.

First of all, how an operator makes a reservation when the operator watches a program promotion will be described with focusing on the input information processing unit 205 with reference to FIG. 2.

When the operator watches the program promotion and desires to reserve the program, the operator operates the input device 202 to cause the input information processing unit 205 to start the program information processing (step S401). Along with the input into the input information processing unit 205, the program information processing unit 301, the character recognition processing unit 303 and the audio recognition processing unit 304 are activated.

Then, the input information processing unit 205 sets termination time of the respective recognition processing units (step S402). In the nature of the program promotion, a keyword required to acquire the reservation information can be extracted by performing the recognition processing for 15 to 30 seconds or one minute at maximum. Therefore, the input information processing unit 205 sets the activation time based on it. Alternatively, another means for permitting the operator to determine the setting time may be separately provided.

After setting the termination time, the input information processing unit 205 causes the character recognition processing unit 303 and the audio recognition processing unit 304 to start the processing, respectively (step S403, step S404). Then, the input information processing unit 205 waits for the recognition processing termination time (step S405: No). When the termination time has been reached (step S405: Yes), the input information processing unit 205 causes the character recognition processing unit 303 and the audio recognition processing unit 304 to terminate the processing (step S406, step S407).

Thereafter, the input information processing unit 205 causes the program information processing unit 301 to start the generation of “reservation candidate” (step S408). The “reservation candidate” mentioned here means a group of plural pieces of information of a program that is to be reserved by a user, which is estimated based on a keyword obtained by character recognition processing and audio recognition processing. The program information has to include, at least, information of the channel, the starting time and finish time. However, the expression method thereof is not particularly limited. Any expression method such as the G-code in which the information is encrypted can be applied if the above three pieces of information can be represented. The accuracy of the reservation candidate can be increased by supplementing it with the information of EPG and the information of a Web page obtained via the network I/F 305 of a broadcasting station.

The input information processing unit 205 waits for the completion of generation of the “reservation candidate” (step S409: No). When the generation of the “reservation candidate” is completed (step S409: Yes), the “reservation candidate” is sent to the character recognition processing unit 303 and the audio recognition processing unit 304. Whether the data is transmitted via the input information processing unit 205 or the “reservation candidate” is directly sent from the program information processing unit 301 thereto is the matter determined in the design stage. Based on the recognition result of the character recognition processing unit 303 and the audio recognition processing unit 304, the existence of the “reservation candidate” is checked. When there is any “reservation candidate”, the “reservation candidate” is acquired (step S410).

Thereafter, the number of the acquired reservation candidates is determined. When there are plural reservation candidates (step S411: Yes), a list of reservation candidates is displayed (step S412). When there is only one reservation candidate (step S411: No), a confirmation screen for fixing the reservation is displayed (step S413).

After displaying the screen, the input information processing unit 205 waits for the input by the operator (step S414: No, step S415: No, step S417: No). When the operator inputs to fix the reservation (step S415: Yes), the reservation processing is performed to terminate the processing (step S416). When the reservation is canceled (step S417: Yes), the processing is terminated without any operations.

As described above, based on the result extracted by the character recognition processing unit 303 and the audio recognition processing unit 304, candidates of reservation times are extracted and are presented to the operator. By this means, the program reservation with a simple input operation can be realized.

Next, the processing of the character recognition processing unit 303 and the audio recognition processing unit 304 will be described.

FIG. 3 is a flow chart showing the processing after the character recognition processing unit 303 is activated.

The character recognition processing unit 303 is activated upon the reception of the activation processing from the input information processing unit 205 at step S403 described above.

Until termination conditions (step S406) are satisfied (step S501: No), the input information processing unit 205 continues to acquire image frames transmitted from the video processing unit 212 (step S502). Character search is performed within the acquired image frames to acquire a character string (step S503). Whether the acquisition processing of the character string is performed for each frame or GOP (Group Of Picture) is the matter changed depending on the type of data to be handled and determined in the design stage.

When the acquisition of all character strings has been finished in the handled unit (step S504: Yes), the processing returns to step S501, and the extraction of the character strings is repeated until the termination conditions are satisfied.

On the other hand, when the termination time of the recognition processing (set by the input information processing unit 205 at step S402) has been reached (step S501: Yes), keywords are extracted from the acquired character strings (step S505). The “keyword” mentioned here means a piece of information required to identify a target to be reserved, and it corresponds to a day of the week, time, a program code of the G-code and the like.

After extracting the keyword, the character recognition processing unit 303 transmits the extracted keyword to the keyword managing unit 302 (step S506) and the processing of the character recognition processing unit 303 is terminated. This corresponds to the step S406 in FIG. 2.

FIG. 4 is a flow chart showing a processing after the audio recognition processing unit 304 is activated.

The audio recognition processing unit 304 is activated upon the reception of the activating processing from the input information processing unit 205 at step S404.

Until the termination conditions (step S407) are satisfied (step S511: No), the input information processing unit 205 acquires audio output data transmitted from the audio processing unit 213 to extract character strings (step S512).

After the termination conditions (step S407) are satisfied (step S511: Yes), keywords are extracted from the acquired character strings (step S513).

After extracting the keywords, the audio recognition processing unit 304 transmits the keyword to the keyword managing unit 302 (step S514), and the processing of the audio recognition processing unit 304 is terminated. This corresponds to the step S407 in FIG. 2.

Note that the method of extracting characters in the character recognition processing unit 303 and the audio recognition processing unit 304 is not particularly limited in this specification.

Further, whether or not the termination of processing of the character recognition processing unit 303 and the audio recognition processing unit 304 is notified to the input information processing unit 205 is the matter determined in the design stage. If it is necessary to smoothly determine the completion of the extraction of the characters at step S409, it is desirable to notify the termination of processing. However, it depends on a decision by an engineer.

FIG. 5 is a flow chart showing a processing of the program information processing unit 301 and the keyword managing unit 302. The processing of the program information processing unit 301 and the keyword managing unit 302 will be described with reference to the flow chart.

When activating the program information processing (step S401 in FIG. 2), the input information processing unit 205 activates the program information processing unit 301 to start the generation of the reservation candidate (step 408 in FIG. 2). The description shown in FIG. 5 is started from the activation of the program information processing unit 301.

The activated program information processing unit 301 first starts the acquisition of a program table (step S601).

Thereafter, the program information processing unit 301 checks whether or not there is the connection to the network (step S602). When there is the connection to the network, the data in a Web of a broadcasting station being watched is acquired via the network I/F 305 (step S603).

Although the acquisition of the program table is described here in a time-series manner, step S601 and step S602 may be selectively performed. In addition, even when both of step S601 and step S602 are performed, step S601 and step S602 may be processed asynchronously in random order.

The keyword managing unit 302 waits for a request for starting the generation of “reservation candidate” from the program information processing unit 301 (step S604: No). When the keyword managing unit 302 receives a request for starting the generation of “reservation candidate” from the program information processing unit 301 (step S604: Yes), the keyword managing unit 302 transmits the keywords transmitted from the character recognition processing unit 303 and the audio recognition processing unit 304 to the program information processing unit 301 (step S605).

After the program information processing unit 301 acquires keywords, the acquired keywords are sorted into the keyword related to time, the keyword acquired immediately before the end of the program promotion, and the keyword duplicated in plural recognition processings, and the priority is set based on the characteristics of the program promotions (step S606).

In accordance with the order of the priority, the program table and the Web data are searched, and information required for the reservation is extracted (step S607). When the program table is to be searched, the search should be made not only for each channel but also for each broadcasting station that is a group of channels (for example, plural channels owned by cable television and NHK (Nippon Hoso Kyokai; Japan Broadcasting Corporation)).

In this manner, based on the extracted pieces of information required for reservation, “reservation candidate” is generated (step S608).

In accordance with the “reservation candidate”, data for selection screen (selection screen data) to be transmitted to the GUI controlling unit 206 is generated (step S609). After receiving the selection screen data, the GUI controlling unit 206 displays the selection screen on the display device 203 via the screen controlling unit 214 to provide selection means to the operator (step S610).

Through the above-described processing procedures, the reservation processing starting from the program promotion is realized.

In the description above, the keyword managing unit 302 is not included in those activated by the input information processing unit 205 at step S401. However, the keyword managing unit 302 may be included in those controlled by the input information processing unit 205 by adding a control signal line from the input information processing unit 205.

Further, the present embodiment is not limited to a single television broadcast receiver, but may be realized by means of software working on a personal computer or the like.

### Second Embodiment

FIG. 6 is an entire configuration diagram of hardware and software according to the second embodiment of the present invention. In the configuration in FIG. 6, a memory buffer 701 and a caption processing unit 702 are included in addition to the constituent elements in FIG. 1.

The memory buffer 701 is inserted between the broadcast receiving unit 210 and the decoding processing unit 211 in the first embodiment. The purpose thereof is to buffer stream data such as TS transmitted from the broadcast receiving unit 210 to the decoding processing unit 211. By this means, the broadcast receiving unit 210 can hold the stream data to be output retroactively for a certain time period. As a result, different from the first embodiment in which the recognition processing is performed from a starting point of the reservation processing obtained from a program promotion by an operation of a viewer, it becomes possible to use the stream data prior to the operation by the viewer in the second embodiment, and the recognition processing retroactive to a starting point of the program promotion can be performed.

Accordingly, the accuracy in the generation of the reservation candidate can be improved.

Also, the caption processing unit 702 is provided, and captions output therefrom are used as targets from which the keywords are extracted. Accordingly, by sending necessary character information in the captions during a program promotion from the side of the broadcasting station, the reservation candidate can be generated reliably. Note that it is assumed in the second embodiment that the caption processing unit 702 itself performs the extraction of the character strings and keywords.

Further, both the memory buffer 701 and the caption processing unit 702 may be employed at the same time, or either one of the memory buffer 701 and the caption processing unit 702 may be applied.

In the foregoing, the invention made by the inventors of the present invention has been concretely described based on the embodiments. However, it is needless to say that the present invention is not limited to the foregoing embodiments and various modifications and alterations can be made within the scope of the present invention.

Judging from the feature of the program promotion that always contains plural pieces of information such as broadcast starting time and broadcast channel required for reservation, the function to make a reservation of a program based on the program promotion by using the television broadcast receiver according to the present invention is not particularly limited to the use for domestic broadcasts in Japan, but it can be also used in various countries by switching the language applied to the recognition processing.

What is claimed is:

1. A television broadcast receiver, comprising:
a decoding processing unit which decodes receiving wave to extract video data; and
a video processing unit which processes the video data into imaging data,
wherein the television broadcast receiver further comprises a character recognition processing unit which extracts a character string from the imaging data.

2. The television broadcast receiver according to claim 1,
wherein the character recognition processing unit extracts one or more keywords from the character string.

3. A television broadcast receiver, comprising:
a decoding processing unit which decodes receiving wave to extract audio data; and
an audio processing unit which converts the audio data into audio output data,
wherein the television broadcast receiver further comprises an audio recognition processing unit which extracts a character string from the audio output data.

4. The television broadcast receiver according to claim 3,
wherein the audio recognition processing unit extracts one or more keywords from the character string.

5. The television broadcast receiver according to claim 2, further comprising: a program information processing unit; and a keyword managing unit,
wherein the character recognition processing unit transmits one or more of the extracted keywords to the keyword managing unit,
the keyword managing unit holds the keywords to be operable by the program information processing unit, and
the program information processing unit determines priority of the keywords held by the keyword managing unit.

6. The television broadcast receiver according to claim 5,
wherein the program information processing unit acquires a program table via a network to determine the priority of the keywords by referring to the program table.

7. The television broadcast receiver according to claim 5,
wherein the program information processing unit generates selection screen data for program reservation by referring to the priority of the keywords.

8. The television broadcast receiver according to claim 7, further comprising a GUI controlling unit,
wherein the program information processing unit transmits the selection screen data to the GUI controlling unit, and
the GUI controlling unit displays reservation candidates in a selectable manner by referring to the selection screen data.

9. The television broadcast receiver according to claim 1, further comprising a memory buffer,
wherein the memory buffer provides a predetermined delay time before the decoding by the decoding processing unit.

10. The television broadcast receiver according to claim 4, further comprising: a program information processing unit; and
a keyword managing unit,
wherein the character recognition processing unit transmits one or more of the extracted keywords to the keyword managing unit,
the keyword managing unit holds the keywords to be operable by the program information processing unit, and the program information processing unit determines priority of the keywords held by the keyword managing unit.

11. The television broadcast receiver according to claim 10,
wherein the program information processing unit acquires a program table via a network to determine the priority of the keywords by referring to the program table.

12. The television broadcast receiver according to claim 10,
wherein the program information processing unit generates selection screen data for program reservation by referring to the priority of the keywords.

13. The television broadcast receiver according to claim 12, further comprising a GUI controlling unit,
wherein the program information processing unit transmits the selection screen data to the GUI controlling unit, and
the GUI controlling unit displays reservation candidates in a selectable manner by referring to the selection screen data.
